(19) United States
(12) Patent Application Publication
(10) Pub. No.: US 2024/0181475 A1
(43) Pub. Date: Jun. 6, 2024

(54) SHOWERHEAD WITH CONVERGING AND DIVERGING SPRAYS

(71) Applicant: ETL, LLC, Sparks, NV (US)

(72) Inventor: David Hofman, Reno, NV (US)

(21) Appl. No.: 18/073,282

(22) Filed: Dec. 1, 2022

(51) Int. Cl. B05B 1/18

(52) U.S. Cl. CPC B05B 1/185

(57) ABSTRACT

A showerhead assembly is provided which includes a showerhead having a faceplate with a plurality of sheer nozzles dispersing flat streams of water. Each sheer nozzle disperses a primary stream of water than converges with a first adjacent stream of water from a first adjacent nozzle, and a second adjacent stream of water from a second adjacent nozzle. Each sheer nozzle converges with the first adjacent stream at a first point of intersection, and the second adjacent stream at a second point of intersection. At the first point of intersection, the primary stream and first adjacent stream diverge into two diverging streams having different trajectories. Similarly, at the second point of intersection, the primary stream and second adjacent stream diverge into two diverging streams having different trajectories. The showerhead can produce a converging stream of water and plurality of diverging streams of water which all spray contemporaneously in different directions.

### BACKGROUND OF THE INVENTION

The present invention relates to showerheads. More particularly, this invention relates to showerheads having a plurality of nozzles that produce converging and diverging streams of water.

Spray heads are commercially available in numerous designs and configurations for use in showers, faucets, spas, sprinklers and other personal and industrial systems. Spray heads may be categorized as being either stationary or oscillating and may have fixed or adjustable openings. Stationary spray heads with fixed jets are the simplest constructions consisting essentially of a central conduit connected to one or more spray jets directed to produce a constant pattern. The stationary spray showerheads cause water to flow through the construction to contact essentially the same points on a user's body in a repetitive fashion.

Multi-function spray heads are able to deliver water in different spray patterns such as fine spray, a coarse spray, a pulsating spray, or even a flood pattern producing a high fluid flow but decreased velocity. In traditional showerheads, water is typically dispersed from spray heads in a diverging spray pattern so as to spray discrete streams of water. Though these spray patterns generally provide adequate water supply for a shower, it would be desirable to have a showerhead with a spray head configured to expand coverage of water dispersion while reducing the amount of water needed to provide such coverage.

Advantageously, some showerhead assemblies include spray heads that produce converging and diverging spray patterns so as to improve the spray pattern's feel and minimize the amount of water needed to provide adequate coverage for the bather. For example, U.S. Pat. No. 8,733,675 discloses a showerhead that includes numerous nozzles that converge and diverge so as to increase water pressure and coverage provided by the showerhead's spray. Specifically, the nozzles are configured to point inwardly so as to provide sprays which intersect or converge at a single point along a central axis of the showerhead. More specifically, as the sprays converge, a confluence occurs wherein a plurality of streams join to form a single stream. Further, the spray pattern diverges from said single point along the central axis so as to disperse a wide spray in the shower. Specifically, as the spray pattern diverges, a plurality of separate sprays form and disperse in an outward direction from said single point. However, in this construction, the water spray surface area is limited due to the spray pattern converging and diverging at a single point along the central axis.

Additionally, U.S. Pat. No. 10,421,083 describes a showerhead producing an expanded spray pattern. In this construction, the showerhead includes nozzles which each disperse a spray that converges with a neighboring spray expelling from a neighboring nozzle so as to form a pentagonal-shaped spray matrix. Specifically, the sprays converge or merge with one another, then diverge into discrete sprays of water projecting in a plurality of trajectories after they have intersected. Though the sprays can each diverge after they converge, they do so in an intersecting manner. Consequently, the diverging sprays overlap and cover the same spray area as the neighboring spray. In this construction, the sprays are directed to the same point on a user's body and, as such, coverage is limited.

Similarly Chinese Patent No. 204412484 provides a showerhead which includes two nozzles wherein the spray patterns converge. However, this embodiment is limited to two nozzles and, in this way, spray divergence is limited to only two directions.

Though these references each describe a showerhead providing a converging and diverging spray pattern, none of the references describe a showerhead producing a spray that converges at multiple varying points, wherein the multiple varying points do not lie along a central axis so as to expand the coverage provided by the spray. Moreover, none of the references provide describe a showerhead producing a spray that diverges into multiple non-intersecting trajectories so as to increase surface area provided by the plurality of diverging sprays. In the foregoing constructions, spray coverage is limited due to the converging nature of the streams. Specifically, as the streams converge, their spray trajectories overlap and, as such, project to relatively the same location in the shower stall. In this way, the sprays do not expand or disperse so as to cover different spaces in the shower stall. Further, in the foregoing constructions, spray coverage is further limited due to the configuration of the diverging streams. Particularly, in U.S. Pat. No. 10,421,083, as the sprays diverge, their diverging trajectories are oriented such that they intersect with one another so as to converge once more. In this manner, the sprays overlap, rather than project in different directions so as to maximize coverage by way of avoiding spray redundancy.

Thus, it would further be advantageous to provide a showerhead assembly that included a showerhead with nozzles configured to disperse water in a manner so as to increase coverage by intersecting with adjacent streams of water at varying converging points and diverging with said adjacent streams of water at varying non-intersecting points projecting in different directions.

Further, it would be advantageous to provide a showerhead assembly that could produce converging and diverging sprays so as to reduce the amount of water needed to provide a high pressure shower experience for the bather. In this manner, the desired showerhead assembly could improve the spray pattern's overall feel and user experience, while also saving water.

### SUMMARY OF THE INVENTION

The present invention addresses the aforementioned disadvantages by providing an improved showerhead assembly which includes a plurality of sheer nozzles that produce converging and diverging streams of water. Specifically, the showerhead assembly includes a showerhead having a housing with a faceplate. More specifically, the faceplate comprises the plurality of sheer nozzles. Preferably, the sheer nozzles are configured to disperse water in a flat or fan-like manner.

Further, the preferred showerhead can be relatively traditional in construction including a showerhead housing connected to a water source. Preferably, a female threaded inlet is threadably engaged to a male threaded pipe providing the source of water. More preferably, the showerhead housing includes a primary conduit configured to be in fluid connection with the female threaded inlet so as to receive water therefrom and transport water to the plurality of sheer nozzles for dispersion therefrom.

In the preferred embodiment, the plurality of sheer nozzles includes at least three sheer nozzles. Each sheer nozzle includes a nozzle inlet, a nozzle outlet, and a tapered chamber. Specifically, the nozzle inlet forms a distal end of the tapered chamber, and the nozzle outlet forms a proximal end of the tapered chamber. More specifically, the nozzle inlet is in fluid connection with the primary conduit so as to receive water therefrom. In this manner, the nozzle inlet can transport said water to the tapered chamber, wherethrough it travels and exits out the nozzle outlet so as to disperse in a flat or fan-shaped stream.

In preferred embodiments, the tapered chamber is configured to taper inwardly so as to decrease in cross-sectional area from the distal end towards the proximal end. Further, the nozzle outlet is sufficiently small in diameter so as to create a constricted area in which the water can be expelled from at a high pressure and high velocity. As the water exits the nozzle outlet, it passes through a cavity formed on a front portion of the sheer nozzle. The cavity is configured so as to have a greater height than the nozzle outlet, but a smaller height than the front end of the sheer nozzle. As such, as water passes through the sheer nozzle, it is dispersed such that it sprays narrow in one direction and wide in another. In this way, the sheer nozzle disperses flat or fan-like streams of water.

Additionally, each sheer nozzle is arranged on the faceplate so as to be adjacent to at least two neighboring sheer nozzles. Preferably, each sheer nozzle is oriented relative to a first adjacent nozzle spraying a first adjacent stream of water, and a second adjacent nozzle spraying a second adjacent stream of water. More preferably, each sheer nozzle is configured and angled relative to said adjacent nozzles so as to spray a stream of water (hereinafter also referred to as a primary stream of water) which converges with the first adjacent stream of water and the second adjacent stream of water. Specifically, the primary stream of water and first adjacent stream of water are configured to converge at a first point of intersection. More specifically, a confluence or merging occurs between the primary stream of water and first adjacent stream of water at the first point of intersection junction so as to form a unified converging stream of water. As such, the converging stream of water includes water from both the primary stream of water and the first adjacent stream of water. In like manner, the primary stream of water and the second adjacent stream of water are configured to converge at a second point of intersection so as to form a converging stream of water comprised of water from both streams. In this way, water is more efficiently used so as to provide a high pressure and improved feel for the bather.

In the preferred embodiment, the primary stream of water and the first adjacent stream of water are further configured to diverge, or separate into discrete streams of water, at the first point of intersection. Specifically, the streams are configured to diverge so as to disperse a first diverging stream of water in a first supplemental trajectory and a second diverging stream of water in a second supplemental trajectory. Similarly, the primary stream of water and the second adjacent stream of water are further configured to diverge at the second point of intersection. Specifically, the streams are configured to diverge so as to disperse a third diverging stream of water in a third supplemental trajectory and a fourth diverging stream of water in a fourth supplemental trajectory.

Preferably, each of the diverging streams is formed from the first point of intersection or the second point of intersection, wherein convergence occurs. In this way, the diverging streams comprise water from a plurality of streams. Specifically, the diverging streams are composed of water from the streams which merged at a respective point of intersection from which a particular diverging stream originates.

In the preferred embodiments, each of the diverging streams of water is spraying in a different direction. Even more preferably, each of the diverging streams of water is spraying in a different direction than the streams of water converging at the first point of intersection and the second point of intersection so as to target different points on the bather. Also more preferably, the streams of water converging at the first point of intersection and the second point of intersection, and the diverging streams of water are configured to disperse water in a contemporaneous fashion. As a result, a predefined spray matrix is defined by the spray trajectories of the diverging streams of water and the converging streams of water at the first point of intersection and the second point of intersection, collectively.

In some preferred embodiments, the faceplate includes three sheer nozzles. In these embodiments, each sheer nozzle is configured such that each primary stream of water converges and diverges with two adjacent streams of water so as to form a triangular spray matrix. In other preferred embodiments, the faceplate includes four sheer nozzles. In such embodiments, each sheer nozzle is configured such that its respective primary stream of water converges and diverges with two adjacent streams of water so as to form an octothorp spray matrix. In yet other preferred embodiments, the faceplate includes five sheer nozzles. Preferably, each sheer nozzle is configured so that each primary stream of water converges and diverges with adjacent streams of water so as to form a pentagonal spray matrix. And, in yet other preferred embodiments, the faceplate includes six sheer nozzles. In these constructions, each sheer nozzle is configured so as to spray a primary stream of water that converges and diverges with adjacent streams of water so as to form a hexagram-shaped spray matrix. Various other sheer nozzle orientations and configurations can be determined by one skilled in the art.

Thus, it is an object of the present invention to provide a showerhead assembly with a plurality of sheer nozzles configured to spray flat streams of water in a diverging and converging fashion. In this way, the showerhead assembly provides for better spray coverage and improved spray pattern feel.

Further, it is an additional object of the present invention to provide a showerhead assembly having converging streams of water that diverge into supplemental streams of water so as to deliver water to different areas without needing to utilize excess water to do so. In this way, water is efficiently used as the interference relationship between the streams creates converging and diverging spray trajectories so as to expand the surface area typically covered by a single stream.

Other features and advantages of the present invention will be appreciated by those skilled in the art upon reading the detailed description which follows with reference to the drawings.

### BRIEF DESCRIPTION OF THE DRAWINGS

These and other, further and more specific objects and advantages of the invention will be apparent to those skilled in the art form the following detailed description thereof, takin in conjunction with the Drawings, in which:

FIG. 1A is a right perspective view depicting an exemplar embodiment of the showerhead assembly having four sheer nozzles, illustrating the sheer nozzles converging and diverging so as to form an octothorp spray matrix.

FIG. 1B is a diagram illustrating the position of the sheer nozzles on the faceplate of the showerhead shown in FIG. 1A, and the supplemental trajectories for the diverging streams of water.

FIG. 2 is an isometric view of a sheer nozzle of the showerhead assemblies described herein.

FIG. 3 is an isometric cutaway view of the sheer nozzle illustrated in FIG. 2.

FIG. 4 is a side cutaway view of the sheer nozzle illustrated in FIG. 2.

FIG. 5A is a top cutaway view of the sheer nozzle illustrated in FIG. 2.

FIG. 5B is a side cutaway view of showerhead including the sheer nozzles shown in FIG. 4 and FIG. 5A.

FIG. 6A is a right perspective view depicting an exemplar embodiment of the showerhead assembly having three sheer nozzles, illustrating the sheer nozzles converging and diverging so as to form a triangular spray matrix.

FIG. 6B is a diagram illustrating the position of the sheer nozzles on the faceplate of the showerhead shown in FIG. 6A, and the supplemental trajectories for the diverging streams of water.

FIG. 7A is a right perspective view depicting an exemplar embodiment of the showerhead assembly having three sheer nozzles, illustrating the sheer nozzles converging and diverging so as to form a triangular spray matrix.

FIG. 7B is a diagram illustrating the position of the sheer nozzles on the faceplate of the showerhead shown in FIG. 7A.

FIG. 8A is a right perspective view depicting an exemplar embodiment of the showerhead assembly having four sheer nozzles, illustrating the sheer nozzles converging and diverging so as to form an octothorp spray matrix.

FIG. 8B is a diagram illustrating the position of the sheer nozzles on the faceplate of the showerhead shown in FIG. 8A.

FIG. 9A is a right perspective view depicting an exemplar embodiment of the showerhead assembly having four sheer nozzles, illustrating the sheer nozzles converging and diverging so as to form an octothorp spray matrix.

FIG. 9B is a diagram illustrating the position of the sheer nozzles on the faceplate of the showerhead shown in FIG. 9A.

FIG. 10A is a right perspective view depicting an exemplar embodiment of the showerhead assembly having five sheer nozzles, illustrating the sheer nozzles converging and diverging so as to form a pentagonal spray matrix.

FIG. 10B is a diagram illustrating the position of the sheer nozzles on the faceplate of the showerhead shown in FIG. 10A.

FIG. 11A is a right perspective view depicting an exemplar embodiment of the showerhead assembly having six sheer nozzles, illustrating the sheer nozzles converging and diverging so as to form a hexagram-shaped spray matrix.

FIG. 11B is a diagram illustrating the position of the sheer nozzles on the faceplate of the showerhead shown in FIG. 11A.

FIG. 12A is a right perspective view depicting an exemplar embodiment of the showerhead assembly having six sheer nozzles, illustrating the sheer nozzles converging and diverging so as to form a hexagram-shaped spray matrix.

FIG. 12B is a diagram illustrating the position of the sheer nozzles on the faceplate of the showerhead shown in FIG. 12A.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

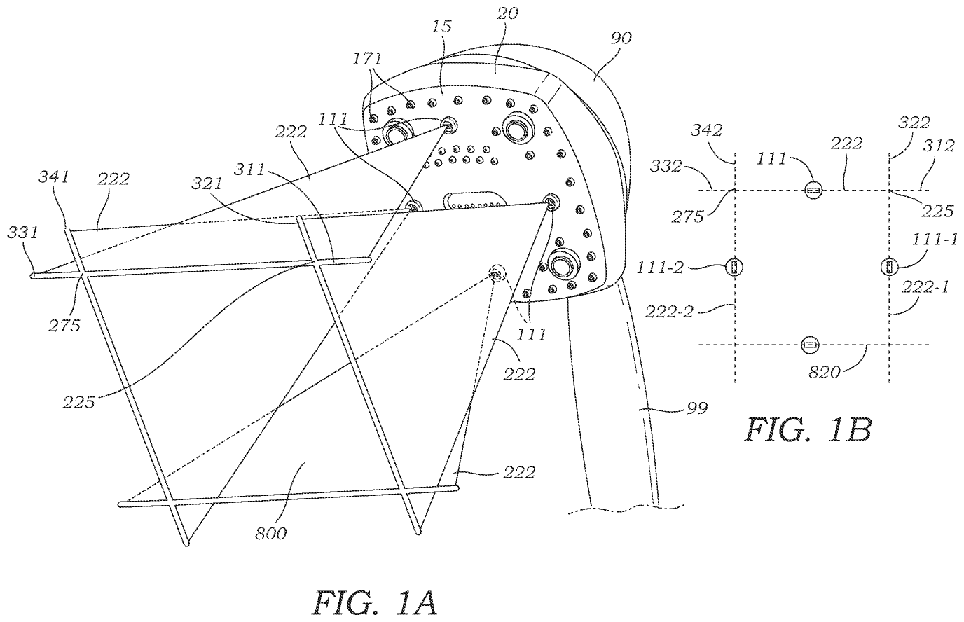

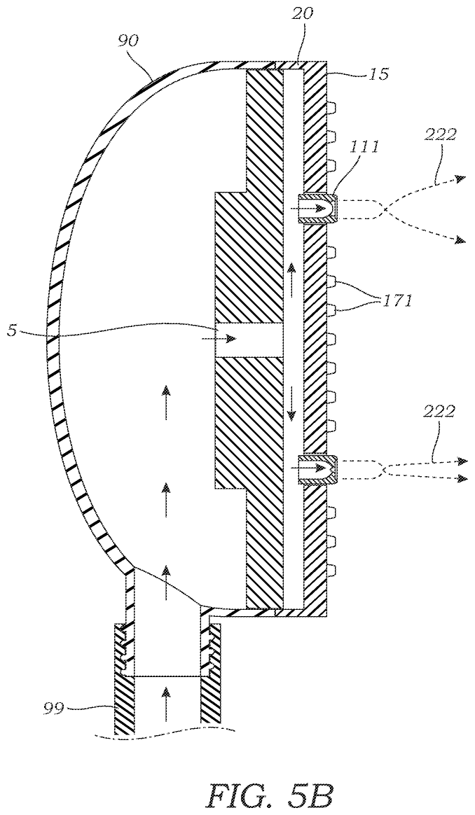

With reference to FIGS. 1A, 1B, 5B and 6A-12B, the water spraying assembly of the present invention is illustrated as a showerhead assembly 1 having a showerhead 90 with a housing 20 which includes a faceplate 15 with a plurality of sheer nozzles 111 projecting therefrom. Like traditional constructions, the preferred showerhead housing 20 is connected to a water source. Preferably, though not illustrated, this showerhead housing 20 includes a longitudinally extending tubular primary conduit 5 in fluid connection with a female threaded inlet that threadably engages to a male threaded pipe providing the source of water. In this manner, the primary conduit 5 can provide water to the plurality of sheer nozzles 111 so as to allow such water to disperse therefrom.

In some preferred embodiments (not shown), the showerhead 90 is constructed as a stationary showerhead 90. In these embodiments, the stationary showerhead 90 can be connected to the water source by a neck portion (not shown). As understood by those skilled in the art, water is capable of flowing through a channel within the neck portion (not shown), which is fluid connection with the primary conduit 5, so as to transport water to the plurality of sheer nozzles 111 on the faceplate 15 of the showerhead housing 20.

In other preferred embodiments, and as illustrated in FIGS. 1A, 5B, 6A, 7A, 8A, 9A, 10A, 11A, and 12A, the showerhead 90 is constructed as a handheld showerhead 90. In these embodiments, the handheld showerhead 90 includes an elongate hollow handle 99 extending longitudinally so as to define a longitudinal axis. Preferably, the faceplate 15 on the handheld showerhead 90 is configured to face an angle between 45° and 90° relative to the elongate hollow handle's 99 longitudinal axis. Though not illustrated, like traditional handheld showerheads, the elongate hollow handle 99 can further include a proximal end threadably affixed to a flexible hose so as to allow the user to control and manipulate the orientation of the showerhead. As understood by those skilled in the art, in these embodiments, water is capable of flowing through a channel (not shown) within a center of the elongate hollow handle 99, which is in fluid connection with the primary conduit 5, so as to transport water to the plurality of sheer nozzles 111 configured to spray water therefrom.

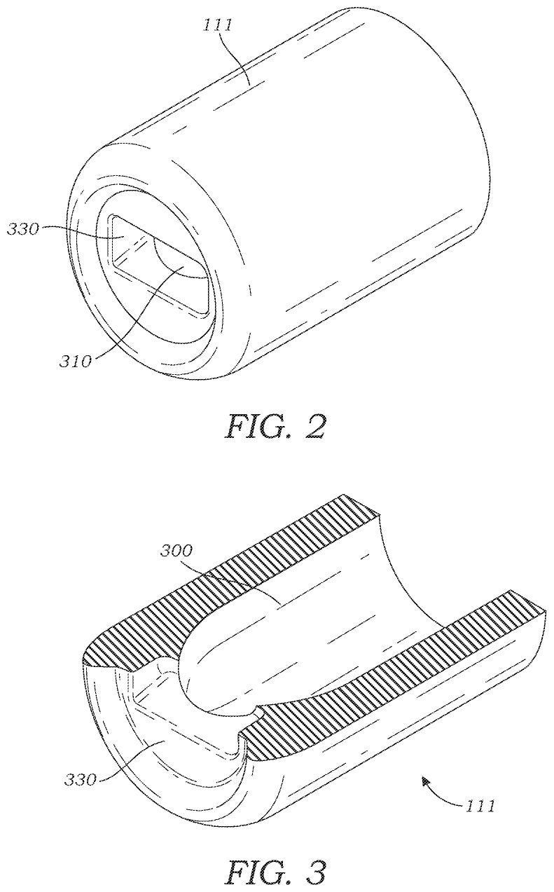

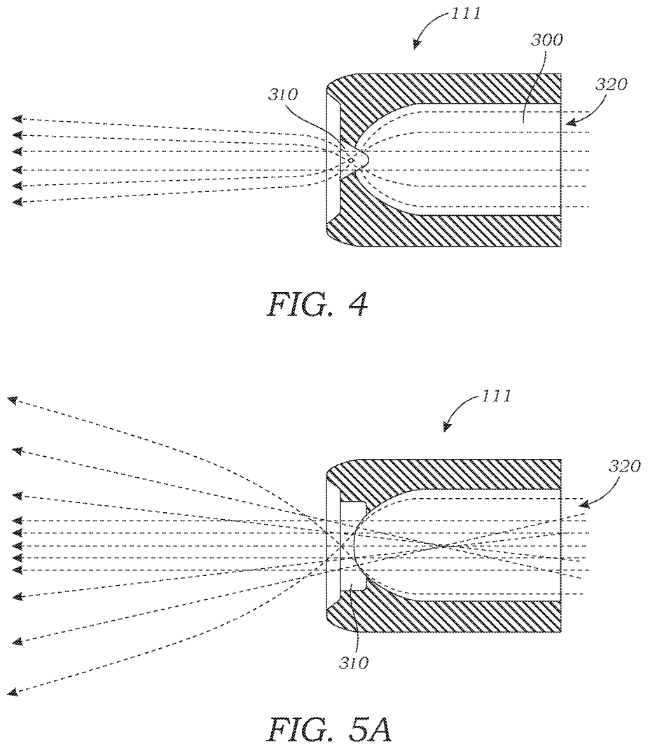

Preferably, the plurality of sheer nozzles 111 includes at least three sheer nozzles (in exemplar embodiments described below, the three sheer nozzles are referred to as 111A, 111B, 111C). More preferably, each sheer nozzle of the plurality of sheer nozzles 111 is configured to disperse water in a flat, fan-shaped, or sheet-like manner. Further, and as illustrated in FIGS. 2-5A, each sheer nozzle 111 includes a tapered chamber 300 configured to transport water. Specifically, the tapered chamber 300 includes a proximal end and a distal end. More specifically, the distal end forms a nozzle inlet 320 which is in fluid connection with the primary conduit 5. Even more specifically, the proximal end forms a nozzle outlet 310. In this manner, the nozzle inlet 320 receives water from the primary conduit 5 so as to allow such water to pass through the tapered chamber 300 and, ultimately, disperse through the nozzle outlet 310.

In preferred embodiments, the tapered chamber 300 is configured to taper inwardly, or towards the proximal end, so as to decrease in cross-sectional area from the distal end towards the proximal end. As such, as water travels downstream from the nozzle inlet 320 to the nozzle outlet 310, the velocity of the water stream increases as the water pressure decreases, consistent with principle's of the Bernoulli Effect. Specifically, given the reduction in fluid pressure that results as water flows through a narrowing cavity, the inwardly tapered shape of the tapered chamber 300 increases the velocity of the water stream traveling through its structure. The tapered chamber 300 may have various shapes providing the aforementioned capabilities, and as can be determined by one skilled in the art. For example, the tapered chamber 300 can be cone-shaped or frusto-conically shaped. However, the preferred tapered chamber 300 has a semi-ellipsoid shape, as illustrated in the FIGS. 3-5A.

In preferred embodiments, the nozzle outlet 310 is sufficiently small in diameter so as to create a constricted area in which the water can be expelled from at a high pressure and high velocity. The nozzle outlet's 310 diameter represents the tapered chamber's 300 smallest cross-sectional diameter. In still a more preferred embodiment, a front portion of the sheer nozzle 111 includes a cavity 330 which is directly adjacent to and extends from the nozzle outlet 310. Specifically, the cavity 330 is configured so as to have a wider diameter than the diameter of the nozzle outlet 310. More specifically, the cavity 330 is configured so as to have a greater height than the height of the nozzle outlet 310, but a smaller height than the height of the front end of the sheer nozzle 111. In this manner, as water exits the nozzle outlet 310 and passes through the cavity 330, it is dispersed so as to form a stream of water narrow in one direction and wide in another. Specifically, in this way, water is dispersed from each sheer nozzle 111 in a flat, fan-shaped, or sheet-like stream. The cavity 330 may have various shapes and diameters providing the aforementioned capabilities, as can be determined by one skilled in the art. For example, the cavity 330 can be rounded rectangular, oval, or racetrack shaped. In the preferred embodiment, the cavity 330 has an oblong shape, as best shown in FIGS. 3-5A.

Further, the showerhead assembly 1 can include a flow restrictor or control valve (not illustrated) so as to maintain a desired sufficient and consistent water flow from each sheer nozzle 111 to enable the streams to converge and then properly diverge after impact. In some embodiments, the flow rate emitted by the flow restrictor is between 1.5 to 2.5 gallons per minute. More preferably, the flow restrictor complies with Federal Energy Policy Act of 1992, which is incorporated by reference herein, and which limits water flow to a maximum of 2.5 gallons per minute at 80 pounds per square inch or 2.2 GPM at 60 psi, whichever is higher. In this manner, the streams are prevented from becoming flaccid or alternatively too fast-moving to provide the desired convergent and divergent effect, as appropriate water velocity and pressure is maintained after expellation through the nozzle outlet 310. Other flow restrictor assemblies and flow rates can be determined by those skilled in the art.

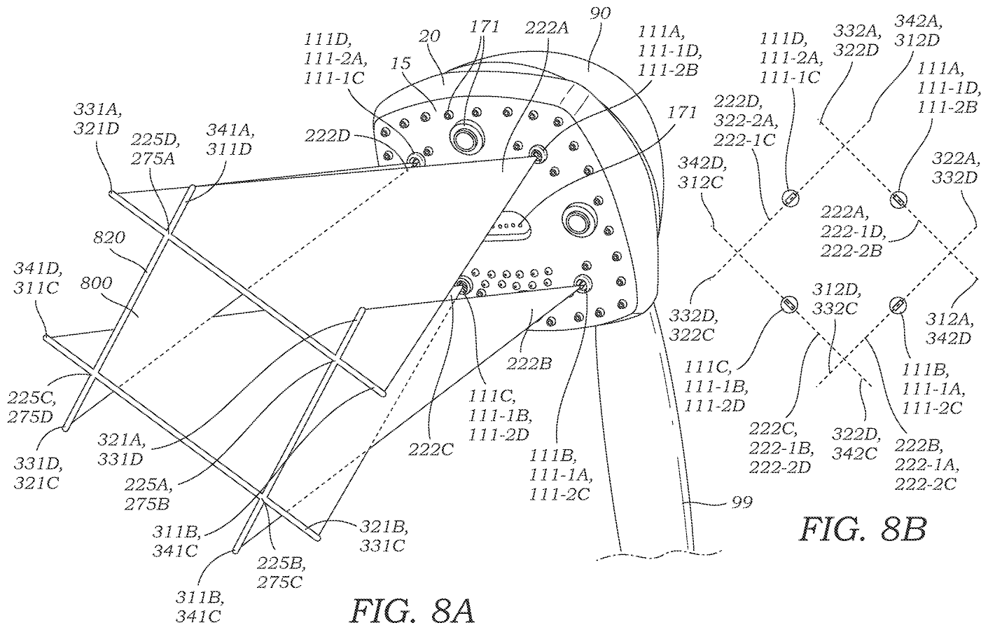

Further, in preferred embodiments, and as best illustrated in FIGS. 1A, 1B, and 5B-12B, each sheer nozzle of the plurality of sheer nozzles 111 is arranged on the faceplate 15 so as to be adjacent to at least two neighboring sheer nozzles (111-1, 111-2). In some preferred embodiments, each sheer nozzle 111 is rotated 90° relative to each adjacent sheer nozzle (111-1, 111-2). In exemplar embodiments, and as illustrated in FIGS. 1A, 1B, 8A, and 8B, each sheer nozzle 111 is rotated 90° relative to a first adjacent sheer nozzle 111-1. Furthermore, each sheer nozzle 111 is rotated 90° relative to a second adjacent sheer nozzle 111-2. Moreover, each sheer nozzle 111 is configured to spray a stream of water 222, also referred to as a primary stream of water or a fan-shaped stream of water. Preferably, each sheer nozzle 111 sprays the primary stream of water 222 in an outward trajectory relative to a central axis of the showerhead 90 so as to increase spray surface area covered by the showerhead assembly 1.

As detailed above, and in preferred embodiments, each sheer nozzle's primary stream of water 222, adjacent streams of water (222-1, 222-2), and all diverging streams of water (311, 321, 331, 341) resulting therefrom, are dispersed in a sheer flat or fan-like fashion. As such, one skilled in the art can understand that the primary stream of water 222, adjacent streams of water (222-1, 222-2), and all diverging streams of water (311, 321, 331, 341) described herein, are flat or fan-shaped streams of water.

Moreover, each sheer nozzle 111 sprays a stream of water 222 than converges with adjacent streams of water (222-1, 222-2) spraying from adjacent sheer nozzles (111-1, 111-2). Specifically, as the stream of water 222 converges with an adjacent stream (222-1, 222-2), a confluence or merging occurs therebetween so as to form a unified converging stream of water. As such, the converging stream of water is composed of water from both the primary stream of water 222 and the converging adjacent stream of water (222-1, 222-2). Preferably, each sheer nozzle 111 sprays a primary stream of water 222 that converges with at least two adjacent streams of water (222-1, 222-2). In the preferred embodiment, each sheer nozzle's stream of water 222 converges with a first adjacent stream of water 222-1 spraying from the first adjacent sheer nozzle 111-1, and a second adjacent stream of water 222-2 spraying from the second adjacent sheer nozzle 111-2.

Specifically, the primary stream of water 222 and first adjacent stream of water 222-1 are configured to converge at a first point of intersection 225. Similarly, the primary stream of water 222 and the second adjacent stream of water 222-2 are configured to converge at a second point of intersection 275. As such, the showerhead assembly utilizes water in a more efficient manner, as each primary stream of water 222 converges with neighboring streams of water (222-1, 222-2), so as to provide an improved and higher pressured spray feel for the bather.

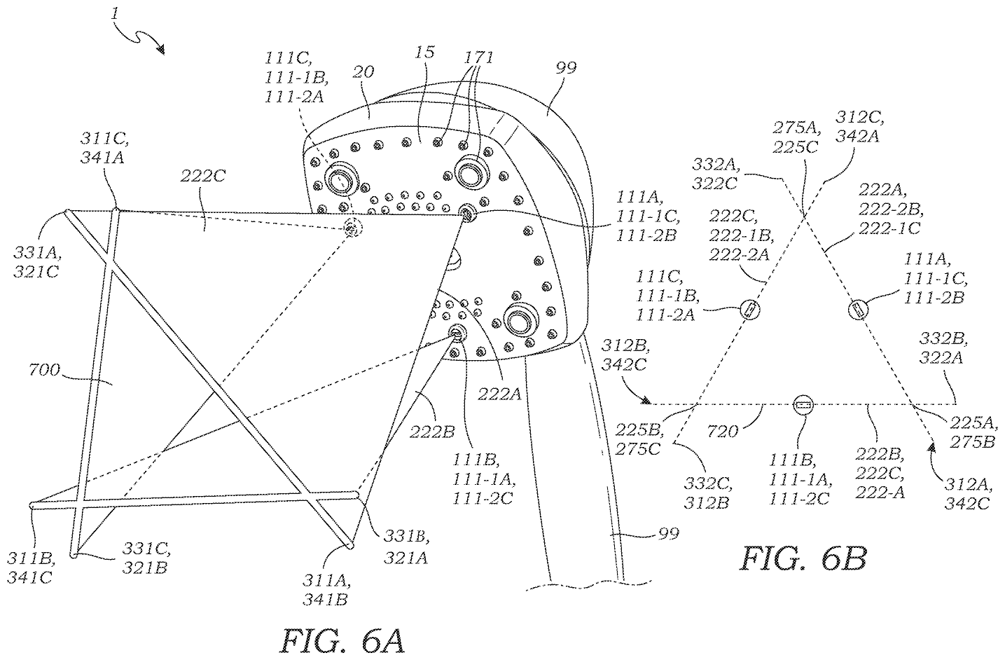

As will become further apparent through the exemplar embodiments described below, in FIGS. 6A-12B, the primary stream of water 222 and its adjacent streams of water (222-1, 222-2) are defined relative to a particular sheer nozzle 111 and its respective adjacent nozzles (111-1, 111-2). As such, one skilled in the art can understand a primary stream of water 222 for a particular sheer nozzle 111 can be considered a first adjacent stream of water 222-1 or a second adjacent stream of water 222-2 relative to primary stream of water 222 spraying from another sheer nozzle 111. Similarly, a sheer nozzle 111 can be considered a first adjacent nozzle 111-1 or a second adjacent nozzle 111-2 relative to a different sheer nozzle 111. In like manner, the first point of intersection 225 and second point of intersection 275 are defined relative to each sheer nozzle 111. Thus, the first point of intersection 225 for one sheer nozzle 111 can be synonymous with the second point of intersection 275 for another sheer nozzle 111.

In the preferred embodiment, and as illustrated in FIGS. 1A, 1B, and 6A-12B, the first point of intersection 225 and the second point of intersection 275 lie along a same longitudinal axis. Preferably, the first point of intersection 225 and the second point of intersection 275 lie along different points on the same longitudinal axis. More preferably, the first point of intersection 225 and second point of intersection 275 are configured such that they do not lie along the central axis defined by the showerhead 90.

Further, and still with reference to FIGS. 1A, 1B, and 5B-12B, at the first point of intersection 225, the primary stream of water 222 and the first adjacent stream of water 222-1 are configured to diverge, or separate into discrete streams, so as to disperse a first diverging stream of water 311 in a first supplemental trajectory 312 and a second diverging stream of water 321 in a second supplemental trajectory 322. In this way, the first diverging stream of water 311 and second diverging stream of water 321 emerge from the first point of intersection 225, the juncture at which the primary stream of water 222 and first adjacent stream of water 222-1 converge. As such, the first diverging stream of water 311 and second diverging stream of water 321 form after the intersection of the streams (222, 222-1) occurs and, thus, can each compose water originating from the primary stream of water 222 and/or the first adjacent stream of water 222-1. In like manner, at the second point of intersection 275, the primary stream of water 222 and the second adjacent stream of water 222-2 are configured to diverge so as to disperse a third diverging stream of water 331 in a third supplemental trajectory 332 and a fourth diverging stream of water 341 in a fourth supplemental trajectory 341. Further, the third diverging stream of water 331 and fourth diverging stream of water 341 form at the second point of intersection 275 after the primary stream 222 and second adjacent stream of water 222-2 converge. As such, the third diverging stream of water 331 and fourth diverging stream of water 341 can each comprise water from the primary stream of water 222 and/or the second adjacent stream of water 222-1.

In some preferred embodiments, and as shown in FIGS. 1B and 6B, the first supplemental trajectory 312 and the second supplemental trajectory 322 are perpendicular to one another, and the third supplemental trajectory 332 and the fourth supplemental trajectory 342 are perpendicular to one another. Further, the first supplemental trajectory 312 and the third supplemental trajectory 332 lie along a same longitudinal axis. Preferably, the first supplemental trajectory 312 and the third supplemental trajectory 332 lie along the same longitudinal axis as the first point of intersection 225 and the second point of intersection 275. In some preferred embodiments, and as best illustrated in FIGS. 1B and 6B, the second supplemental trajectory 322 and the fourth supplemental trajectory 342 lie along a same longitudinal axis.

With reference to FIGS. 1A, 1B, and 6A-12B, in the preferred embodiments, the first supplemental trajectory 312 and the second supplemental trajectory 322 do not intersect. Similarly, the third supplemental trajectory 332 and the fourth supplemental trajectory 342 do not intersect. Further, in the preferred embodiment, none of the supplemental trajectories (312, 322, 332, 342) intersect with one another. In this way, each of the diverging streams of water (311, 321, 331, 341) is spraying in a different direction. Preferably, the converging streams of water at the first point of intersection 225 and the second point of intersection 275 are spraying water in a different trajectory than each of the diverging streams of water (311, 321, 331, 341). More preferably, the first diverging stream of water 311 is configured to spray in an opposite trajectory from the third diverging stream of water 331

Even more preferably, in some embodiments, the second supplemental trajectory 322 and the fourth supplemental trajectory 342 can be parallel to one another so as to spray the second diverging stream of water 321 and the fourth diverging stream of water 341, respectively, in a parallel fashion. Further, the converging streams of water at the first point of intersection 225 and the second point of intersection 275, and the diverging streams of water (311, 321, 331, 341) are configured to disperse water in a contemporaneous fashion. In this manner, the showerhead 90 is able to spray water in a plurality of directions so as to target different points on the bather and increase coverage provided by the showerhead assembly 1. Specifically, the spray coverage provided by the showerhead assembly 1 is maximized as each stream of water 222 converges and diverges at different points and diverges in different non-intersecting trajectories from one another, so as to not overlap with other sprays and expand the surface area covered.

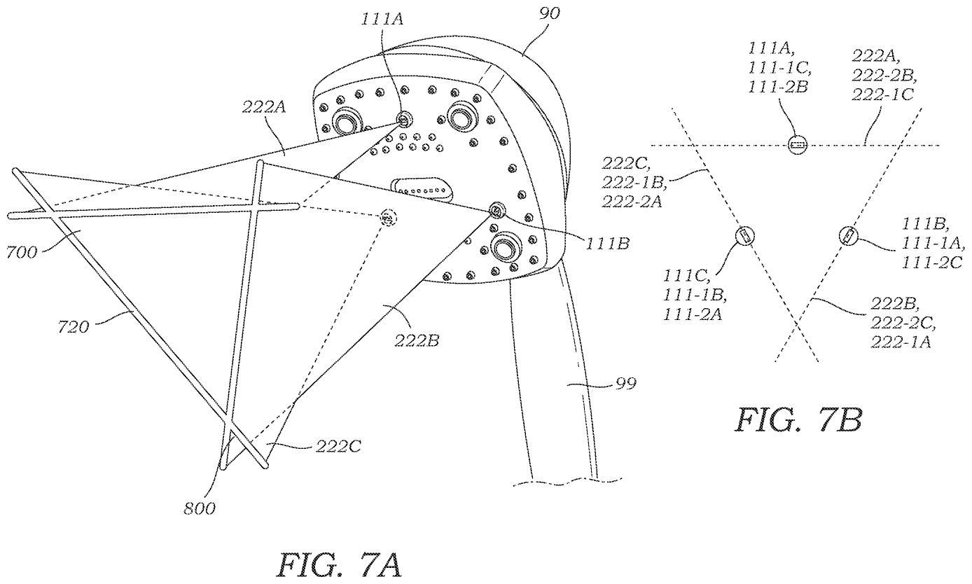

With reference to FIGS. 6A-7B, in some preferred embodiments, the faceplate 15 includes three sheer nozzles (111A, 111B, 111C). Preferably, the three sheer nozzles (111A, 111B, 111C) can be arranged on the faceplate 15 so as to be equidistant one another. Further, (1) “A” sheer nozzle 111A can be arranged adjacent to “B” sheer nozzle 111B and “C” sheer nozzle 111C; (2) “B” sheer nozzle 111B can be arranged adjacent to “C” sheer nozzle 111C and “A” sheer nozzle 111A; and, consequently (3) “C” sheer nozzle 111C can be arranged adjacent to “A” sheer nozzle 111A and “B” sheer nozzle 111B. In this way, “B” sheer nozzle 111B can be defined as the first adjacent sheer nozzle 111-1A relative to “A” sheer nozzle 111A, and “C” sheer nozzle 111C can be defined as the second adjacent sheer nozzle 111-2A relative to “A” sheer nozzle 111A. Additionally, “C” sheer nozzle 111C can be defined as the first adjacent sheer nozzle 111-1B relative to “B” sheer nozzle 111B, and “A” sheer nozzle 111A can be defined as the second adjacent sheer nozzle 111-1B relative to “B” sheer nozzle 111B. As such, “A” sheer nozzle 111A can be defined as the first adjacent sheer nozzle 111-1C relative to “C” sheer nozzle 111C, and “B” sheer nozzle 111B can be defined as the second adjacent sheer nozzle 111-2C relative to “C” sheer nozzle 111C. Various other sheer nozzle positions, orientations, and configurations can be determined by one skilled in the art.

Further, the three sheer nozzles (111A, 111B, 111C) are configured such that their respective streams of water (222A, 222B, 222C) converge and diverge so as to define a triangular spray matrix 700. Moreover, each sheer nozzle's first point of intersection (225A, 225B, 225C) and second point of intersection (275A, 275B, 275C), collectively, define an inner perimeter 720 of the triangular spray matrix 700. Specifically, the inner perimeter 720 forms a triangle shape. In some preferred embodiments, the interior angles of the inner perimeter 720 can be about 120°.

Moreover, each sheer nozzle's (111A, 111B, 111C) first supplemental trajectory (312A, 312B, 312C) and third supplemental trajectory (332A, 332B, 332C) defines its maximum spray width. The maximum spray width defines a maximum spray coverage each sheer nozzle (111A, 111B, 111C) covers by way of converging and diverging its spray. Specifically, each first supplemental trajectory (312A, 312B, 312C) defines a first end of each maximum spray width, and each third supplemental trajectory (332A, 332B, 332C) defines a second end of the maximum spray width. More specifically, the first point of intersection (225A, 225B, 225C) and the second point of intersection (275A, 275B, 275C) for each primary stream of water (222A, 222B, 222C) lie along different points between the first end and the second end of its respective maximum spray width. Even more specifically, a center point between the first end and the second end (lies along a central axis defined by each respective sheer nozzle (111A, 111B, 111C). In this way, the maximum spray width's center point is longitudinally aligned with the central axis of its respective sheer nozzle (111A, 111B, 111C). Additionally, each of the three sheer nozzles' (111A, 111B, 111C) maximum spray widths, collectively, define an outer perimeter of the triangular spray matrix. Further, the supplemental trajectories (312A, 312B, 312C, 322A, 322B, 322C, 332A, 332B, 332C, 342A, 342B, 342C) of the three sheer nozzles (111A, 111B, 111C) define outer corners of the triangular spray matrix 700.

In the showerhead assembly 1 embodiment illustrated in FIGS. 7A and 7B, the positioning of the sheer nozzles (111A, 111B, 111C) on the faceplate are different from that of FIGS. 6A and 6B. As such, the resulting converging and diverging streams form a triangular spray matrix 700 having a different triangular configuration than that which is produced from the showerhead assembly 1 of FIGS. 6A and 6B. Various other nozzle 111 positions and orientations can be determined by those skilled in the art.

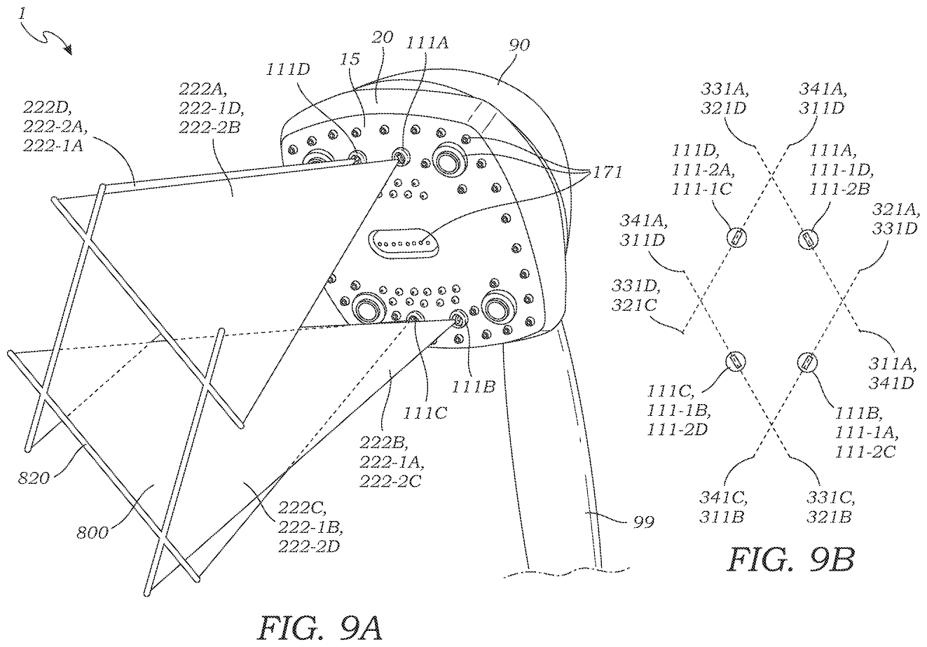

In some preferred embodiments, and as best illustrated in FIGS. 8A-9B, the showerhead includes a faceplate with four sheer nozzles (111A, 111B, 111C, 111D). Preferably, the sheer nozzles (111A, 111B, 111C, 111D) can be arranged so as to be equidistant from neighboring or adjacent sheer nozzles (111-1A, 111-1B, 111-C, 111-D, 111-2A, 111-2B, 111-2C, 111-2D). In some exemplar embodiments, (1) “A” sheer nozzle 111A can be arranged adjacent to “B” sheer nozzle 111B and “D” sheer nozzle 111D; (2) “B” sheer nozzle 111B can be arranged adjacent to “C” sheer nozzle 111C and “A” sheer nozzle 111A; (3) “C” sheer nozzle 111C can be arranged adjacent to “D” sheer nozzle 111D and “B” sheer nozzle 111B; and, as such, (4) “D” sheer nozzle 111D can be arranged adjacent to “A” sheer nozzle 111A and “C” sheer nozzle 111C.

In this way, “B” sheer nozzle 111B can be defined as the first adjacent sheer nozzle 111-1A relative to “A” sheer nozzle 111A, and “D” sheer nozzle 111D can be defined as the second adjacent sheer nozzle 111-2A relative to “A” sheer nozzle. Moreover, “C” sheer nozzle 111C can be defined as the first adjacent sheer nozzle 111-1B relative to “B” sheer nozzle 111B, and “A” sheer nozzle 111A can be defined as the second adjacent sheer nozzle 111-2B relative to “B” sheer nozzle 111B. Similarly, “D” sheer nozzle 111D can be defined as the first adjacent sheer nozzle 111-1C relative to “C” sheer nozzle 111C, and “B” sheer nozzle 111B can be defined as the second adjacent sheer nozzle 111-2C relative to “C” sheer nozzle 111C. In like manner, “A” sheer nozzle 111A can be defined as the first adjacent sheer nozzle 111-1D relative to “D” sheer nozzle 111D, and “C” sheer nozzle 111C can be defined as the second adjacent sheer nozzle 111-2D relative to “D” sheer nozzle 111D.

In these embodiments, “A” sheer nozzle's primary stream of water 222A converges with the adjacent streams of water (222-1A, 222-2A) spraying from “B” sheer nozzle 111B and “D” sheer nozzle 111D. Specifically, “A” sheer nozzle's primary stream 222A converges with the first adjacent stream of water 222-1A spraying from “B” sheer nozzle 111B at a first point of intersection 225A, and with the second adjacent stream of water 222-2A spraying from “D” sheer nozzle 111D at a second point of intersection 275A. In like manner, “B” sheer nozzle's primary stream of water 222B converges with the first adjacent stream of water 222-1B spraying from “C” sheer nozzle” 111C at a first point of intersection 225B, and the second adjacent stream of water 222-2B spraying from “A” sheer nozzle 111A at the second point of intersection 275B. As such, “A” sheer nozzle's first point of intersection 225A is the same point of intersection as “B” sheer nozzle's second point of intersection 275B.

Moreover, “C” sheer nozzle's primary stream of water 222C converges with the adjacent streams of water (222-1C, 222-2C) spraying from “D” sheer nozzle 111D and “B” sheer nozzle 111B. Specifically, “C” sheer nozzle's primary stream of water 222C converges with the first adjacent stream of water 222-1C spraying from “D” sheer nozzle 111D at a first point of intersection 225C, and with the second adjacent stream of water 222-2C spraying from “B” sheer nozzle 111B at a second point of intersection 275C. As such, “C” sheer nozzle's second point of intersection 275C is the same point of intersection as “B” sheer nozzle's first point of intersection 225B.

Similarly, “D” sheer nozzle's primary stream of water 222D converges with the adjacent streams of water (222-1D, 222-2D) spraying from “A” sheer nozzle 111A and “C” sheer nozzle 111C. “D” sheer nozzle's primary stream converges 222D with the first adjacent stream of water 222-1D spraying from “A” sheer nozzle 111A at a first point of intersection 225D, and with the second adjacent stream of water 222-2D spraying from “C” sheer nozzle 111C at a second point of intersection 275D. Consequently, “D” sheer nozzle's second point of intersection 275D is the same point of intersection as “C” sheer nozzle's first point of intersection 225C. Further, “D” sheer nozzle's first point of intersection 225D is the same point of intersection as “A” sheer nozzle's second point of intersection 275A.

Preferably, the four sheer nozzles (111A, 111B, 111C, 111D) are configured such that their respective streams of water (222A, 222B, 222C, 222D) converge and diverge with respective adjacent streams of water (222-1A, 222-1B, 222-1C, 222-1D, 222-2A, 222-2B, 222-2C, 222-2D) so as to form an octothorp spray matrix 800. In this embodiment, each sheer nozzles first point of intersection (225A, 225B, 225C, 225D) and second point of intersection (275A, 275B, 275C, 275D), collectively, define an inner perimeter 820 of the octothorp spray matrix 800. Specifically, the inner perimeter 820 forms a quadrangle. In some preferred embodiments, and as illustrated in the embodiments shown in FIGS. 1A, 1B, 8A, and 8B, the interior angles of the inner perimeter 820 can form 90° of the quadrangle. In exemplar embodiments, the inner perimeter 820 can form a rectangle, square, trapezoid, rhombus, or other various quadrangle shapes determined by those skilled in the art.

Preferably, each of the four sheer nozzle's first supplemental trajectory (312A, 312B, 312C, 312D) and third supplemental trajectory (332A, 332B, 332C, 332D) define a maximum spray width for that respective sheer nozzle (111A, 111B, 111C, 111D). For example, “A” sheer nozzle 111A can spray a primary stream of water 222A having a maximum spray width defined by its first diverging stream's first supplemental trajectory 312A and its third diverging stream's third supplemental trajectory 332A. Specifically, the first supplemental trajectory (312A, 312B, 312C, 312D) defines a first end of the maximum spray width, and the third supplemental trajectory (332A, 332B, 332C, 332D) defines a second end of the maximum spray width. More specifically, the maximum spray width includes a center point between the first end and the second end. The center point is configured such that it is longitudinally aligned with the central axis of the “A” sheer nozzle 111A. Further the first end, the second end, and the center point for each sheer nozzle (111A, 111B, 111C, 111D) are oriented such that they do not align with the central axis of the showerhead 90. Moreover, the four sheer nozzles' (111A, 111B, 111C, 111D) maximum spray widths, collectively, define an outer perimeter of the octothorp spray matrix 800. Preferably, the supplemental trajectories (312A, 312B, 312C, 312D, 322A, 322B, 322C, 322D, 332A, 332B, 332C, 332D, 342A, 342B, 342C, 342D) form outer corners of the octothorp spray matrix 800.

FIGS. 9A and 9B illustrate an alternative embodiment of the showerhead assembly 1 having a faceplate 15 with four sheer nozzles (111A, 111B, 111C, 111D). In this construction, the showerhead assembly 1 is similar to the embodiments described in FIGS. 8A and 8B, with the exception of the sheer nozzles (111A, 111B, 111C, 111D) on the faceplate 15 being positioned in a different orientation than those shown in the FIGS. 1A, 1B, 8A, and 8B showerhead assembly 1. Specifically, in the embodiments shown in FIGS. 1A, 1B, 8A, and 8B, each sheer nozzle (111A, 111B, 111C, 111D) is arranged equidistant to each adjacent sheer nozzle (111-1A, 111-1B, 111-1C, 111-1D, 111-2A, 111-2B, 111-2C, 111-2D) on the faceplate 15. In the embodiment illustrated in FIGS. 9A and 9B, however, each sheer nozzle (111A, 111B, 111C, 111D) is closer in distance to one adjacent sheer nozzle (111-1A, 111-1B, 111-1C, 111-1D, 111-2A, 111-2B, 111-2C, 111-2D) than it is to another adjacent sheer nozzle (111-1A, 111-1B, 111-1C, 111-1D, 111-2A, 111-2B, 111-2C, 111-2D). In this manner, the streams of water (222A, 222B, 222C, 222D, 311A, 311B, 311C, 311D, 321A, 321B, 321C, 321D, 331A, 331B, 331C, 331D, 341A, 341B, 341C, 341D) produced by the sheer nozzles (111A, 111B, 111C, 111D) form an octothorp spray matrix 800 having a different configuration that those illustrated in FIGS. 1A, 1B, 8A and 8B.

Specifically, in this embodiment, the sheer nozzles (111A, 111B, 111C, 111D) are positioned such that the resulting octothorp spray matrix 800 has an inner perimeter 820 having two interior angles greater than 90° and two interior angles less than 90°. In this way, the spray emitted from the showerhead 90 is configured such that it contacts a different area than the embodiments illustrated in FIGS. 1A, 1B, 8A, and 8B. In this manner, the positioning of the sheer nozzles (111A, 111B, 111C, 111D), and the resulting constructions of the octothorp spray matrix 800 resulting therefrom can dictate the different areas the showerhead 90 targets in the shower stall. Various nozzle positions, orientations, and configurations can be determined by those skilled in the art.

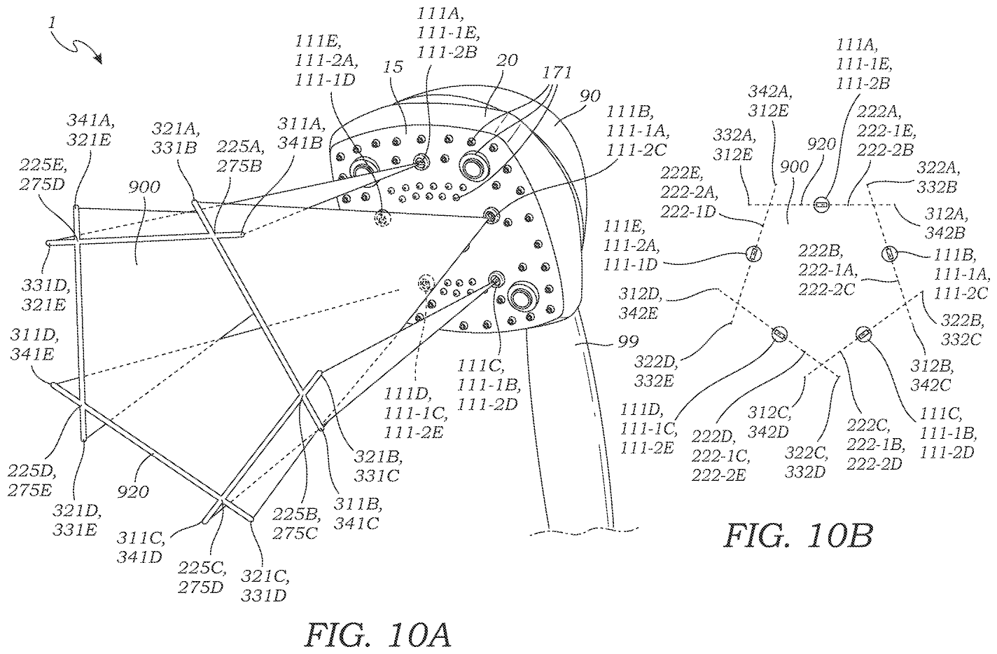

In another preferred embodiment, and as illustrated in FIGS. 10A and 10B, the showerhead 90 includes a faceplate 15 with five sheer nozzles (111A, 111B, 111C, 111D, 111E). Preferably, the sheer nozzles (111A, 111B, 111C, 111D, 111E) can be positioned on the faceplate 15 such that each sheer nozzle (111A, 111B, 111C, 111D, 111E) is equidistant to each adjacent sheer nozzle (111-1A, 111-1B, 111-1C, 111-1D, 111-1E, 111-2A, 111-2B, 111-2C, 111-2D, 111-2E). More preferably, the sheer nozzles (111A, 111B, 111C, 111D, 111E) can be arranged such that the resulting converging and diverging streams form a pentagonal spray matrix 900. In some exemplar embodiments, (1) “A” sheer nozzle 111A can be arranged adjacent to “B” sheer nozzle 111B and “E” sheer nozzle 111E; (2) “B” sheer nozzle 111B can be arranged adjacent to “C” sheer nozzle 111C and “A” sheer nozzle 111A; (3) “C” sheer nozzle 111C can be arranged adjacent to “D” sheer nozzle 111D and “B” sheer nozzle 111B; (4) “D” sheer nozzle 111D can be arranged adjacent to “E” sheer nozzle 111E and “C” sheer nozzle 111C; and, as such, (5) “E” sheer nozzle 111E can be arranged adjacent to “A” sheer nozzle 111A and “D” sheer nozzle 111D.

In this way, “B” sheer nozzle 111B can be defined as the first adjacent sheer nozzle 111-1A relative to “A” sheer nozzle 111A, and “E” sheer nozzle 111E can be defined as the second adjacent sheer nozzle 111-2A relative to “A” sheer nozzle 111A. Moreover, “C” sheer nozzle 111C can be defined as the first adjacent sheer nozzle 111-1B relative to “B” sheer nozzle 111B, and “A” sheer nozzle 111A can be defined as the second adjacent sheer nozzle 111-2B relative to “B” sheer nozzle 111B. Similarly, “D” sheer nozzle 111D can be defined as the first adjacent sheer nozzle 111-1C relative to “C” sheer nozzle 111C, and “B” sheer nozzle 111B can be defined as the second adjacent sheer nozzle 111-2C relative to “C” sheer nozzle 111C. In like manner, “E” sheer nozzle 111E can be defined as the first adjacent sheer nozzle 111-1D relative to “D” sheer nozzle 111D, and “C” sheer nozzle 111C can be defined as the second adjacent sheer nozzle 111-1D relative to “D” sheer nozzle 111D. As such, “A” sheer nozzle 111A can be defined as the first adjacent sheer nozzle 111-1E relative to “E” sheer nozzle 111E, and “D” sheer nozzle 111D can be defined as the second adjacent sheer nozzle 111-2E relative to “E” sheer nozzle 111E. Various other nozzle orientations and configurations can be determined by those skilled in the art.

In this embodiment, “A” sheer nozzle's primary stream of water 222A converges with the adjacent streams of water (222-1A, 222-2A) spraying from “B” sheer nozzle 111B and “E” sheer nozzle 111E. “A” nozzle's primary stream 222A converges with the first adjacent stream of water 222-1A spraying from “B” sheer nozzle 111B at a first point of intersection 225A, and with the second adjacent stream of water 222-2A spraying from “E” sheer nozzle 111E at a second point of intersection 275A. Additionally, “B” sheer nozzle's primary stream of water 222B converges with the adjacent streams of water (222-1B, 222-2B) spraying from “C” sheer nozzle” 111C and “A” sheer nozzle 111A. “B” sheer nozzle's primary stream of water 222B converges with the first adjacent stream of water 222-1B spraying from “C” sheer nozzle 111C at a first point of intersection 225B, and with the second adjacent stream of water 222-2B spraying from “A” sheer nozzle 111A at a second point of intersection 275B. In this manner, “A” sheer nozzle's first point of intersection 225A is the same point of intersection as “B” sheer nozzle's second point of intersection 275B.

Moreover, “C” sheer nozzle's primary stream of water 222C converges with the adjacent streams of water (222-1C, 222-2C) spraying from “D” sheer nozzle” 111D and “B” sheer nozzle 111B. “C” sheer nozzle's primary stream of water 222C converges with the first adjacent stream of water 222-1C spraying from “D” nozzle 111D at a first point of intersection 225C, and with the second adjacent stream of water 222-2C spraying from “B” nozzle 111B at a second point of intersection 275C. As such, “C” sheer nozzle's second point of intersection 275C is the same point of intersection as “B” sheer nozzle's first point of intersection 225B.

Similarly, “D” sheer nozzle's primary stream of water 222D converges with the adjacent streams of water (222-1D, 222-2D) spraying from “E” sheer nozzle” 111E and “C” sheer nozzle 111C. Specifically, “D” sheer nozzle's primary stream of water 222D converges with the first adjacent stream of water 222-1D spraying from “E” sheer nozzle 111E at a first point of intersection 225D, and with the second adjacent stream of water 222-2D spraying from “C” sheer nozzle 111C at a second point of intersection 275D. Consequently, “D” sheer nozzle's second point of intersection 275D is the same point of intersection as “C” sheer nozzle's first point of intersection 225C.

In like manner, “E” sheer nozzle's primary stream of water 222E converges with the adjacent streams of water (222-1E, 222-2E) spraying from “A” sheer nozzle” 111A and “D” sheer nozzle 111D. “E” sheer nozzle's primary stream of water 222E converges with the first adjacent stream of water 222-1E spraying from “A” sheer nozzle 111A at a first point of intersection 225E, and with the second adjacent stream of water 222-2E spraying from “D” sheer nozzle 111D at a second point of intersection 275E. Consequently, “E” sheer nozzle's second point of intersection 275E is the same point of intersection as “D” sheer nozzle's first point of intersection 225D. Further, “E” sheer nozzle's first point of intersection 225E is the same point of intersection as “A” sheer nozzle's second point of intersection 275A.

In this embodiment, each sheer nozzles' first point of intersection (225A, 225B, 225C, 225C, 225D, 225E) and second point of intersection (275A, 275B, 275C, 275D, 275E), collectively, define an inner perimeter 920 of the pentagonal spray matrix 900. Specifically, the inner perimeter 920 forms a pentagonal shape. In the preferred embodiment, and as illustrated in the embodiments shown in FIGS. 10A and 10B, the interior angles of the inner perimeter can be greater than 90°.

Preferably, each of the five sheer nozzle's first supplemental trajectory (312A, 312B, 312C, 312D, 312E) and third supplemental trajectory (332A, 332B, 332C, 332D, 332E) define a maximum spray width for that respective sheer nozzle (111A, 111B, 111C, 111D, 111E). Moreover, the five sheer nozzles' 111A, 111B, 111C, 111D, 111E) maximum spray widths, collectively, define an outer perimeter of the pentagonal spray matrix 900. Further, the supplemental trajectories (312A, 312B, 312C, 312D, 312E, 322A, 322B, 322C, 322D, 322E, 332A, 332B, 332C, 332D, 332E, 342A, 342B, 342C, 342D, 342E) form outer corners of the pentagonal spray matrix 900.

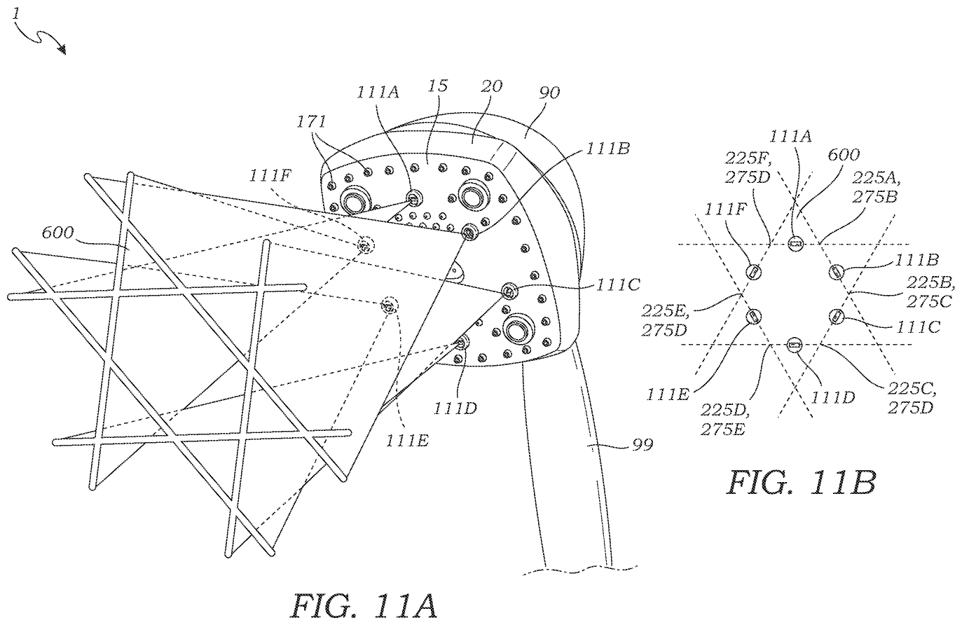

The showerhead assembly 1 depicted in FIGS. 11A and 11B is similar to the previously described embodiments, with the exception of the showerhead 900 including a faceplate 15 with six sheer nozzles (111A, 111B, 111C, 111D, 111E, 111F). Similar to the previous embodiments, the sheer nozzles (111A, 111B, 111C, 111D, 111E, 111F) can be positioned on the faceplate 15 such that the resulting converging and diverging streams form a predefined spray matrix.

Specifically, in the embodiment illustrated in FIGS. 11A and 11B, a hexagram-shaped spray matrix 600 is formed.

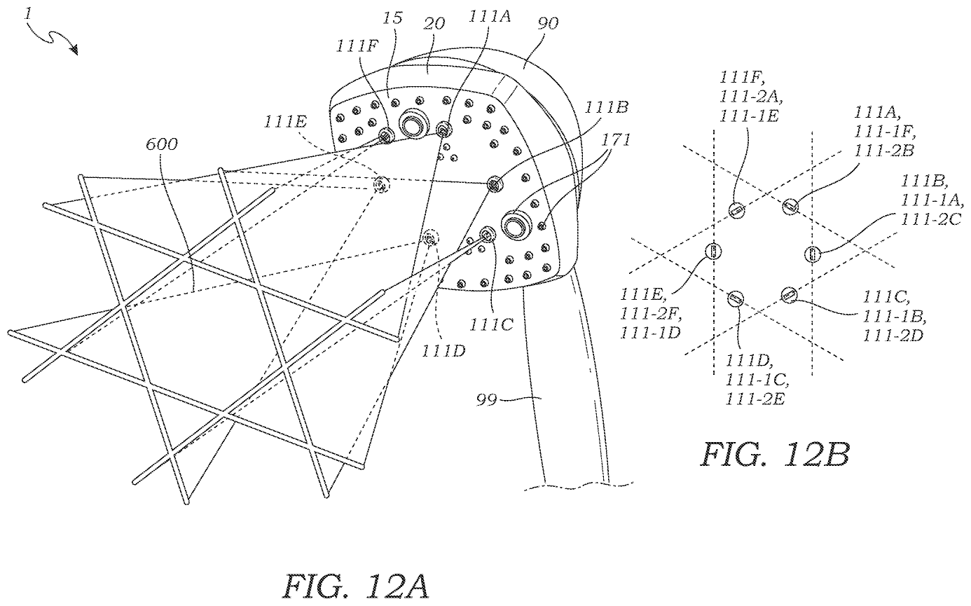

FIGS. 12A and 12B illustrate an alternative embodiment of the showerhead assembly 1 comprising six sheer nozzles (111A, 111B, 111C, 111D, 111E, 111F). The showerhead assembly 1 illustrated in FIGS. 12A and 12B is similar to the embodiment shown in FIGS. 11A and 11B, with the exception of the sheer nozzles (111A, 111B, 111C, 111D, 111E, 111F) on the faceplate 15 being positioned in a different orientation than those shown in the FIGS. 11A and 11B showerhead assembly 1. Specifically, in this embodiment, the sheer nozzles (111A, 111B, 111C, 111D, 111E, 111F) are each equidistant from each adjacent sheer nozzle (111-1A, 111-1B, 111-1C, 111-1D, 111-1E, 111-1F, 111-2A, 111-2B, 111-2C, 111-2D, 111-2E, 111-2F). As such, in the embodiment shown in FIGS. 12A and 12B, the resulting converging and diverging streams form a hexagram-shaped spray matrix 600 having a different configuration than that which formed in the showerhead assembly 1 of FIGS. 11A and 11B.

As illustrated in FIGS. 1A, 1B, and 6A-12B, the showerhead assembly 1 embodiments described herein can further include supplemental or ancillary nozzles 171 projecting from the faceplate 15. Further the ancillary nozzles 171 can be configured to spray in a contemporaneous fashion with the sheer nozzles 111. In some embodiments, the ancillary nozzles 171 can converge and diverge with the streams of water (222, 222-1, 222-2, 311, 321, 331, 341) produced by the sheer nozzles 111. In other embodiments, the ancillary nozzles 171 are configured to spray in a direction and angle such that they do not intersect with the stream trajectories (312, 322, 332, 342) of the sheer nozzles 111. Various ancillary nozzle constructions providing the aforementioned capabilities can be determined by those skilled in the art.

While a preferred showerhead assembly comprising a converging and diverging streams of water has been illustrated and described, it would be apparent that various modifications can be made to the showerheads and assembly without departing from the spirit and scope of the invention. Accordingly, it is not intended that the invention be limited except by the following claims. Having described the invention in such terms to enable a person skilled in the art to understand the invention, recreate the invention, and practice it, and having identified the presently preferred embodiments thereof, I claim:

1. A water spraying assembly comprising:
a showerhead including a housing having a faceplate with a plurality of sheer nozzles projecting from said faceplate; and
a primary conduit configured to receive water from a water source and transport such water to said plurality of sheer nozzles,
wherein each sheer nozzle of said plurality of sheer nozzles is configured to spray a stream of water that disperses narrow in one direction and wide in another so as to provide a fan-shaped stream of water, wherein said fan-shaped stream of water is configured to converge with a first adjacent fan-shaped stream of water and a second adjacent fan-shaped stream of water, wherein said fan-shaped stream of water and said first adjacent fan-shaped stream of water are configured to converge at a first point of intersection, wherein said fan-shaped stream of water and said second adjacent fan-shaped stream of water are configured to converge at a second point of intersection, and
wherein said fan-shaped stream of water and said first adjacent fan-shaped stream of water are further configured to diverge at said first point of intersection so as to disperse a first diverging fan-shaped stream of water in a first supplemental trajectory and a second diverging fan-shaped stream of water in a second supplemental trajectory, wherein said first supplemental trajectory and said second supplemental trajectory do not intersect, wherein said fan-shaped stream of water and said second adjacent fan-shaped stream of water are further configured to diverge at said second point of intersection so as to disperse a third diverging fan-shaped stream of water in a third supplemental trajectory and a fourth diverging fan-shaped stream of water in a fourth supplemental trajectory, and wherein said third supplemental trajectory and said fourth supplemental trajectory do not intersect.

2. The water spraying assembly of claim 1, wherein said each sheer nozzle of said plurality of sheer nozzles is arranged adjacent to a first adjacent sheer nozzle of said plurality of sheer nozzles spraying said first adjacent fan-shaped stream of water, wherein said each sheer nozzle of said plurality of sheer nozzles is arranged adjacent a second adjacent sheer nozzle of said plurality of sheer nozzles spraying said second adjacent fan-shaped stream of water.

3. The water spraying assembly of claim 2, wherein said each sheer nozzle of said plurality of sheer nozzles is rotated 90° relative to said first adjacent sheer nozzle of said plurality of sheer nozzles, and wherein said each sheer nozzle of said plurality of sheer nozzles is rotated 90° relative to said second adjacent sheer nozzle of said plurality of sheer nozzles.

4. The water spraying assembly of claim 1, wherein said first point of intersection and said second point of intersection lie along a same longitudinal axis.

5. The water spraying assembly of claim 1, wherein said first point of intersection and said second point of intersection lie along different points on a same longitudinal axis.

6. The water spraying assembly of claim 1, wherein said showerhead defines a central axis, and wherein said first point of intersection and said second point of intersection do not lie along said central axis.

7. The water spraying assembly of claim 1, wherein said first supplemental trajectory and said second supplemental trajectory are perpendicular to one another, and wherein said third supplemental trajectory and said fourth supplemental trajectory are perpendicular to one another.

8. The water spraying assembly of claim 1, wherein said first supplemental trajectory and said third supplemental trajectory lie along a same first longitudinal axis, and wherein said second supplemental trajectory and said fourth supplemental trajectory lie along a same second longitudinal axis.

9. The water spraying assembly of claim 8, wherein said first diverging fan-shaped stream of water is configured to spray in an opposite trajectory from said third diverging fan-shaped stream of water.

10. The water spraying assembly of claim 8, wherein said second supplemental trajectory and said fourth supplemental trajectory are parallel, and wherein second diverging fan-shaped stream of water is configured to spray in a same longitudinal trajectory as said fourth diverging fan-shaped stream of water.

11. The water spraying assembly of claim 1, wherein said first supplemental trajectory and said third supplemental trajectory lie along a same longitudinal axis as said first point of intersection and said second point of intersection.

12. The water spraying assembly of claim 1, wherein said each sheer nozzle of said plurality of sheer nozzles is further configured to spray said fan-shaped stream of water in an outward trajectory relative to a central axis of said showerhead.

13. The water spraying assembly of claim 1, wherein said plurality of sheer nozzles includes four sheer nozzles, and wherein each of said four sheer nozzles is configured to spray said fan-shaped stream of water that converges and diverges with said first adjacent fan-shaped stream of water and said second adjacent fan-shaped stream of water so as to form an octothorp spray matrix.

14. The water spraying assembly of claim 13, wherein said first point of intersection and second point of intersection of each of said four nozzles are configured to define an inner perimeter of said octothorp spray pattern, wherein said inner perimeter forms a quadrangle.

15. The water spraying assembly of claim 13, wherein a distance between said first supplemental trajectory and said third supplemental trajectory defines a maximum spray width of said octothorp spray matrix, wherein said first supplemental trajectory defines a first end of said maximum spray width and said third supplemental trajectory defines a second end of said maximum spray width, and wherein said first point of intersection and said second point of intersection each lie along a point between said first end and said second end.

16. The water spraying assembly of claim 13, wherein said first supplemental trajectory, said second supplemental trajectory, said third supplemental trajectory, and said fourth supplemental trajectory define an outer perimeter of said octothorp spray matrix.

17. The water spraying assembly of claim 1, wherein said plurality of sheer nozzles includes at least three sheer nozzles.

18. The water spraying assembly of claim 1, wherein said first point of intersection defines a first converging fan-shaped stream of water configured to spray in a first primary trajectory, wherein said second point of intersection defines a second converging fan-shaped stream of water configured to spray in a second primary trajectory, and wherein said first primary trajectory, second primary trajectory, first supplemental trajectory, said second supplemental trajectory, said third supplemental trajectory, and said fourth supplemental trajectory each disperse in a different direction than one another.

19. The water spraying assembly of claim 18, wherein said first converging fan-shaped stream of water and said second converging fan-shaped stream of water are configured to disperse at a same time as said first diverging fan-shaped stream of water, said second diverging fan-shaped stream of water, said third diverging fan-shaped stream of water, and said fourth diverging fan-shaped stream of water.

20. The water spraying assembly of claim 1, wherein said showerhead is a handheld showerhead, wherein handheld showerhead includes an elongate hollow handle extending longitudinally to define a longitudinal axis, and wherein said faceplate is configured to face an angle between 45° and 90° relative to said elongate hollow handle's longitudinal axis.

21. The water spraying assembly of claim 1, wherein said faceplate includes one or more ancillary nozzles configured to disperse water at a same time as said plurality of sheer nozzles.

22. The water spraying assembly of claim 1, wherein said each sheer nozzle is positioned on said faceplate so as to spray said fan-shaped stream of water that converges and diverges with said first adjacent fan-shaped stream of water and said second adjacent fan-shaped stream of water so as to form a spray matrix predefined by the positioning of said each sheer nozzle on said faceplate.
